(19) United States
(12) Patent Application Publication
(10) Pub. No.: US 2004/0194917 A1
(43) Pub. Date: Oct. 7, 2004

(54) EGR gas cooling mechanism

(76) Inventor: Shoichiro Usui, Numazu-shi (JP)

Correspondence Address: JORDAN AND HAMBURG LLP, 122 EAST 42ND STREET, SUITE 4000, NEW YORK, NY, 10168, US

(21) Appl. No.: 10/751,378

(22) Filed: Jan. 5, 2004

(30) Foreign Application Priority Data
Jul. 19, 2002 (JP) 2002-210622

(51) Int. Cl. F01P 1/00; G05D 23/00

(52) U.S. Cl. 165/51; 165/287

(57) ABSTRACT

An EGR gas cooling apparatus includes a heat exchanger coupled to an introduction route and a delivery route for a thermal medium fluid having a high boiling point of 150 degree Celsius or higher and placed at a body pipe formed with an EGR gas flowing route at one end of which an inlet for the EGR gas is arranged and at the other end of which an outlet for the EGR gas is arranged, thereby improving preventive effects on soot attachments and condensed liquid attachments on the flowing route for the EGR gas, and minimizing reduction of thermal conduction efficiency of the heat conduction pipe due to soot to render the apparatus perform the heat exchange between the EGR gas and the cooling medium liquid.

### BACKGROUND OF THE INVENTION

1. Field of the Invention

This invention relates to an EGR (Exhaust Gas Recirculation) cooling mechanism performing thermal exchange between ERG gas and a cooling medium liquid for preventing soot attachment and condensation of condensed liquid in the ERG cooling mechanism to cool the ERG gas.

2. Description of Related Art

Conventionally, EGR systems in which a part of exhaust gas is taken out of an exhaust gas system and returned to an intake system of the engine to be added to the mixture gas and the intake air, are used in engines for automobiles along with gasoline engines and diesel engines. With the EGR system, particularly with the cooled EGR system for diesel engines of high EGR rate, an EGR gas cooling apparatus for cooling the EGR gas at a high temperature with cooling water, cooling air, cooling medium for air conditioner, or other cooling medium liquidsis provided to reduce nitrogen oxide gas (NOx) in the exhaust gas, to prevent the mileage from becoming inferior, and to prevent functions and durability of the EGR valve from deteriorated due to excessively increased temperature.

The EGR gas cooling apparatus performs thermal exchange between the EGR gas and the cooling medium liquid via heat conduction pipes and heat conduction plates by disposing, at a thermal exchanger, plural heat conduction pipes having smaller diameters through the interior of which the EGR gas can communicate and heat conduction plates and by flowing the proper cooling medium liquid along the external circumference of the thermal exchanger, to cool the EGR gas.

As the heat conduction pipes used in the above apparatus, arts as described in Japanese Patent Application Publication Nos. JA-11-108,578 and JA-2001-227,413 have been known. With those conventionally known heat conduction pipes, the EGR gas communicating through the interior thereof little receives flowing resistance because the inner circumferential surface is smooth, so that the soot contained in the EGR gas may be deposited on the inner surface of the heat conduction pipes. With the pipes above, also, the surface temperature of the heat conduction surface is overly lowered where the EGR gas amount is so small as to render the exchanging heat amount small, or where the apparatus is chilled due to the winter season or the like.

Under such a lowered temperature, such as vapor, unburned gas, sulfuric acid solution, and carbon hydride contained in the EGR gas are condensed and liquidized to be deposited on the inner surface of the heat conduction pipes, thereby solving the soot in those liquids, and easily forming a moisture soot layer having a high bulk density of particles with a high viscosity on the inner circumferential surface of the heat conduction pipes. According to this principle, the soot deposited on the inner surfaces of the heat conduction pipes and the heat conduction plates create a heat insulation effect to reduce the thermal exchange efficiency between the EGR gas and the cooling medium, so that it is undesirable as diminishing functions in terms of the heat conduction. Furthermore, where the condensed liquid is deposited on and attached to the inner surface of the heat conduction pipes, the structural members such as the heat conduction pipes may be easily subject to corrosion.

As a method to remove the soot from the inner surface of the heat conduction surface, adapted are to prevent the soot from depositing by forming a low energy coating such as fluoric resin on the inner surface of the heat conduction surface, to design a flowing route system of the heat conduction surface so as to blow the soot away with fluid force of the EGR gas by raising the flowing rate of the EGR gas, to wipe the deposited soot with a member in a blush shape, or to rinse the soot using a rinsing liquid.

With the heat conduction surface on which the low energy coating is formed, the thermal conduction rate is so low as to reduce the thermal exchange efficiency, and the function as the thermal exchanger may be lost, whereas there raises a problem on heat resisting property. With the method for blowing the soot away, it is required to make extremely faster the flowing rate of the EGR gas to do adequately the blowing away operation, but to the contrary, pressure loss for that portion may be increased, and therefore it is not desirable for the present cooled EGR system. With the method for wiping the soot off using the blush or the like, it is not easy to set up a blush structure in the apparatus, and its reliability may raise some problems. Wiping off the soot manually may resultantly reduce the workability significantly, not only because many processing steps are needed but also because the cooling operation in the heat conduction pipes and the heat conduction plates has to be stopped. Even with the method using the rinsing liquid, not only it is difficult to set up the blush in substantially the same way as the above method, but also the rinsing liquid may be fed into the combustion chamber, and therefore, the engine's combustion may be disturbed according to the type of the selected rinsing liquid.

### SUMMARY OF THE INVENTION

This invention is to solve the above problems. It is an object of the invention to provide an EGR gas cooling mechanism enhancing soot deposition preventive effects to flowing routes of the EGR gas such as heat conduction pipes and heat conduction plates and being capable of removing, from inner circumferential surfaces of the flowing routes, soot even where deposited once on the inner surface of the flowing routes. It is another object of the invention to provide an EGR gas cooling mechanism resultantly capable of effectively performing thermal exchanging between the EGR gas flowing through the flowing routes and the cooling medium liquid flowing along the outer circumference of the flowing routes where minimizing reduction of the thermal conduction rate of the flowing routes due to soot. It is yet another object of the invention to provide an EGR gas cooling mechanism obtainable of high reliability where the structural members such as heat conduction pipes are not subject to corrosion because the mechanism can prevent the liquid from condensing at the inner surface of the heat conduction pipes.

To solve the above problems, the first invention is for an EGR gas cooling mechanism comprising: a heat exchanger coupled to an introducing route and a delivery route for a cooling medium liquid for cooling EGR gas, the heat exchanger comprising: a body pipe having an inlet for the EGR gas located at one end and an outlet for the EGR gas located at the other end; a flowing route for EGR gas provided inside the body pipe, wherein a thermal medium fluid having a high boiling point of 150 degrees Celsius or higher is supplied as the cooling medium liquid to the heat exchanger to prevent soot and condensed liquid from being attached to an inner surface of the flowing route of the EGR gas by heating operation for the inner surface of the flowing route of the EGR.

The second invention is for an EGR gas cooling mechanism comprising: a heat exchanger coupled to an introducing route and a delivery route for a cooling medium liquid for cooling EGR gas, the heat exchanger comprising: a body pipe having an inlet for the EGR gas located at one end and an outlet for the EGR gas located at the other end; a flowing route for EGR gas provided inside the body pipe, wherein a controller for controlling supply of the cooling medium liquid is provided at the flowing route in which a thermal medium fluid having a high boiling point of 150 degrees Celsius or higher is supplied as the cooling medium liquid to the heat exchanger.

The controller may be constituted of a circulation pump disposed at the introduction route for the cooling medium liquid and a control valve, and a supplying amount of the cooling medium liquid supplied to the heat exchanger may be controlled by either or both of increasing and decreasing operation for flowing amount of the circulation pump and opening and closing operation of the control valve. The controller may control the supplying amount of the cooling medium liquid to the heat exchanger according to any of temperature or temperatures at the surface of the flowing route of the EGR, the outlet of the cooling medium liquid, and the outlet of the EGR gas. Moreover, the heating operation for the inner surface of the flowing route of the EGR gas may be made in a range between 120 degrees Celsius and 150 degrees Celsius.

With this invention thus structured, soot deposition onto the inner surface of the EGR gas flowing route such as heat conduction pipes and heat conduction plates as described above greatly depends on the surface temperature of the heat conduction surface, and the soot may deposit more as the surface temperature of the flowing route is lower. Vapor, unburned gas, sulfuric acid solution, and carbon hydride contained in the EGR gas are condensed and liquidized to be deposited on the inner surface of the heat conduction pipes where the surface temperature of the flowing route is low, and therefore, separation or blowing away of the soot may be difficult because the soot may be solved in those liquids and because a moisture soot layer having a high bulk density with a high viscosity is formed on the inner surface of the flowing route. This moisture soot layer makes worse the thermal conduction rate of the flowing route, so that the layer causes a problem that the heat exchange rate at the heat exchanger is lowered.

Conversely, where the surface temperature of the flowing route is relatively high, the deposition from the liquids may occur rarely, and a dry soot layer may be formed with relatively low bulk density of the particles and with low viscosity. According to an experiment conducted along this invention, it is turned out that separation and blowing out of the soot from the flowing routes may be done more easily as the bulk density of the particles is lower and as the viscosity is lower.

Thus, in this invention, a thermal medium fluid having a high boiling point of 150 degrees Celsius or higher is supplied as the cooling medium liquid to the heat exchanger, thereby preventing soot from depositing, as well as changing the soot deposited on the inner surface into the dry soot with relatively low bulk density of the particles and with low viscosity, and thereby promoting separation or blowing away of the soot by flowing force of the EGR gas. It is to be noted that if the inner surface temperature of the flowing route is made higher, the cooling medium liquid boils partly around the outer periphery of the heat conduction pipes where using a cooling medium liquid, such as a coolant, having a relatively low boiling point, so that parts of the heat exchanger may be broken down or deteriorated. It is therefore required to heat the inner surface temperature of the flowing route using various high-boiling point cooling medium liquids having a boiling temperature of 150 degrees Celsius or higher as the cooling medium liquid, without boiling the cooling medium liquids. The reason to use the high-boiling point cooling medium liquids having a boiling temperature of 150 degrees Celsius or higher as the cooling medium liquid is for the purpose of prevention of cooling medium liquid boiling, and therefore, though the liquid having a boiling point below 150 degrees Celsius is not suitable, the upper limitation of the boiling point is not necessarily determined as far as the boiling point exceeds 150 degrees Celsius or higher, so that various high-boiling point cooling medium liquids having a boiling temperature of 150 degrees Celsius or higher can be used.

In the second invention, with the EGR gas cooling mechanism, the EGR gas burned in the combustion chamber is flown from an exhaust manifold into a flowing route via an inlet of a body pipe. In a meantime, a cooling medium liquid made of a high-boiling point cooling medium liquid having a boiling temperature of 150 degrees Celsius or higher is continuously fed via an introduction route according to control from the controller to a heat exchanger provided at the exterior of the flowing route, and is delivered to a delivery route after flown along the outer peripheral surface of the flowing route. Heat exchange is performed, within the heat exchanger through which the cooling medium liquid is normally circulated, between the cooling medium liquid made of the high-boiling point cooling medium liquid having a boiling temperature of 150 degrees Celsius or higher and the EGR gas via the inner and outer surfaces of the flowing route whose inner surface is heated, and the adequately cooled EGR gas is returned to an intake manifold side via the outlet.

Where the inner surface temperature of the flowing route is set in a range between 120 degrees Celsius and 150 degrees Celsius, the mechanism can prevent soot and condensed liquid from attaching, and with this invention, heating periodically or temporarily also can be done. To do this, the supplying amount of the cooling medium liquid to the heat exchanger is reduced or the supply is stopped by control according to the controller. According to this limitation of the supplying amount of the cooling medium liquid, the heat exchange rate is reduced at the heat exchanger, and the temperature of the inner surface of the flowing route is increased by heat of the EGR gas.

When the inner surface temperature of the flowing route reaches a certain high temperature or higher, preventive effects of soot attachments onto the inner surface of the flowing route become further effective, and the soot can be separated or blown away easily by the flowing force of the EGR gas even where depositing, so that the soot may be pulverized into smaller ones and delivered together with the EGR gas from the delivery outlet. Such small and dry soot may not affect the internal combustion mechanism even where fed to the intake manifold side.

With this heating operation, the heat exchange between the EGR gas and the cooling medium liquid at the heat exchanger can be continued in a range between 120 degrees Celsius and 150 degrees Celsius by increasing the supplying amount of the cooling medium liquid to the heat exchanger or resuming the supply according to the control from the controller, and because the mechanism can adequately prevent the soot and condensed liquid from attaching and can remove the soot as described above, the mechanism can prevent the heat conduction property of the flowing route from deteriorated due to soot, thereby being capable of effectively heat exchanging. Therefore, the functionality of the EGR gas cooling can be activated, and the effect on malfunction preventions of the apparatus can also be raised. Cooling operation at the engine and the heat exchanger can be done without stoppage, so that the mechanism possess excellent advantages, The controller can be in any structure as far as the supply of the cooling medium liquid is controllable, and for example, it is constituted of a circulation pump disposed at an introduction route of the cooling medium liquid and a control valve. The supplying amount of the cooling medium liquid can be controlled by increasing and decreasing the flowing amount of the circulation pump as well as by opening and closing the control valve.

To render the soot depositing at the flowing route separable or allowable to be blown away within a range of the regular flowing rate of the EGR gas, it is desirable to continue the operation that the inner surface temperature of the heat conduction pipe is in a range between 120 degrees Celsius and 150 degrees Celsius. The cooling medium liquid, therefore, does not boil by using the thermal medium fluid having a high boiling point of 150 degrees Celsius or higher as the cooling medium liquid even where the inner surface temperature of the heat conduction pipe is heated from 120 degrees Celsius to 150 degrees Celsius, is not required to be subject to high pressure, can safely perform prevention work against soot attachment as well as removal work of soot, and can bring products high durable with high functionality in preventing the EGR gas cooling mechanism from broken down or deteriorated. It is to be noted that fluoric inert solvent or the like can be used as the thermal medium fluid having a high boiling point of 150 degrees Celsius.

Where measuring any of temperature or temperatures at the surface of the flowing route of the EGR, the outlet of the cooling medium liquid, and the outlet of the EGR gas, the controller may control the supplying amount of the cooling medium liquid to the heat exchanger based on measured amounts. By measuring any one of the above temperatures, the controller surely detects the temperature reduction at the flowing route and adjusts the flowing amount of the cooling medium liquid, thereby effectively performing prevention work against attachments of soot and condensed liquid due to a high temperature occurring at the flowing route. The controller also renders the flowing route surely reach the targeted temperature, and prevents the temperature from excessively increasing, thereby improving the functionality against soot and the durability of the apparatus.

The controller can effectively do prevention work against soot due to heating at the flowing route and removal work of soot upon operation thereof in case that soot deposition occurs at the flowing route through not so mach required where the mechanism uses the thermal medium fluid having a high boiling point of 150 degrees Celsius as the cooling medium liquid.

### BRIEF DESCRIPTION OF THE DRAWINGS

The above and other objects, features and advantages of the present invention will become more apparent from the following description of the presently preferred exemplary embodiments of the invention taken in conjunction with the accompanying drawing, in which:

FIG. 1 is a system illustration showing a cooled EGR system according to the first embodiment of the invention.

### DETAILED DESCRIPTION OF REFERRED EMBODIMENTS

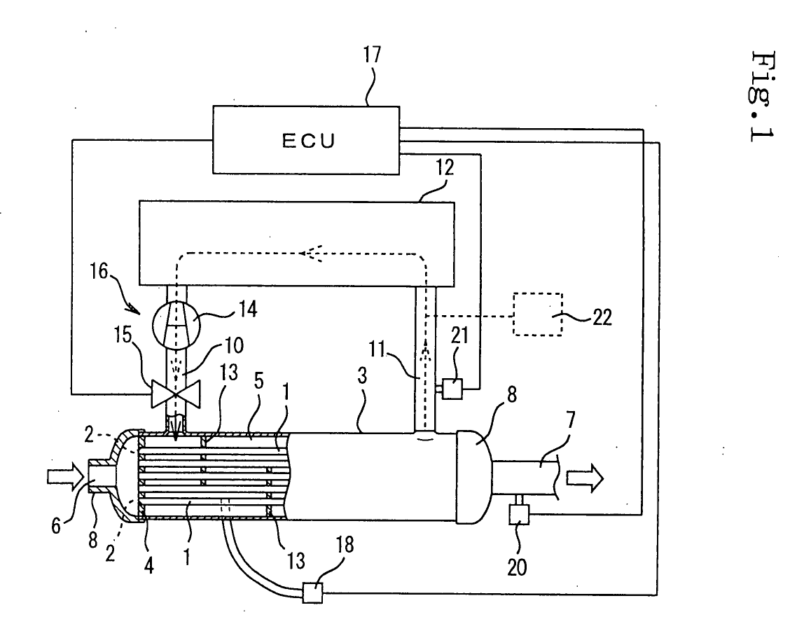

Hereinafter, according to the invention, an embodiment in which an EGR gas cooling apparatus is used in a cooled EGR system for automobiles is described in reference to FIG. 1. Numeral 1 is a heat conduction pipe in which the EGR gas can flow through a flowing route 2 formed in the interior of the pipe. The heat conduction pipe 1 raises the thermal conduction rate of the heat conduction pipe 1 and makes flow of the EGR gas disordered in the flowing route 2 by providing undulations on the inner surface of the flowing route 2 or intemrally arranging spiral-shaped fin members or the like to increase the contact area to the EGR gas.

Where the entire apparatus is chilled due to a low external temperature, or where the exchanging heat amount is reduced due to a lower inflowing amount of the EGR gas, and if the inner surface temperature of the flowing route 2 of the EGR gas becomes lower, a wet soot layer having a relatively low bulk density of the particles and a low viscosity, tends to be formed easily on the inner surface, and from this wet soot deposition, the thermal conductance of the heat conduction pipe 1 is deteriorated, thereby rendering worse the heat exchange efficiency, and possibly causing to generate corrosions of the members, such as e.g., the heat conduction pipe 1, upon condensation of moisture in the exhaust gas. Conversely, as confirmed through an experiment done with this invention, if the inner surface temperature of the flowing route 2 of the EGR gas becomes higher, soot deposition can be prevented, and the wet soot already deposited is dried and changed to a dry soot having a low bulk density of the particles and a low viscosity, so that separation or blown away operation of the soot can be done easily from the inner surface of the flowing route 2.

Accordingly, a thermal medium fluid having a high boiling point of 150 degrees Celsius or higher, such as a fluoric inert solvent or the like, is used, and it is designed that the inner surface temperature of the flowing route 2 of the heat conduction pipe 1 is heated to 120 degrees Celsius to 150 degrees Celsius whereas the cooling medium liquid does not boil. If the inner surface temperature of the flowing route 2 is lower than 120 degrees Celsius, preventive effect on soot attachment may be reduced, and condensation upon condensed moisture in the exhaust gas may occur. If the inner surface temperature of the flowing route 2 is higher than 150 degrees Celsius, cooling effect of the exhaust gas is lowered, and the apparatus becomes one hardly producing functions as the EGR gas cooling apparatus. In the EGR gas cooling apparatus, as shown in FIG. 1, a pair of tube sheets 4 is coupled around each end of a cylindrical body pipe 3 so as to be capable of sealing the interior, and a sealed space partitioned with the tube sheets 4 is used as a heat exchange portion 5 for performing heat exchange between the EGR gas and the cooling medium liquid. Plural heat conduction pipes 1 are disposed between the pair of the tube sheets 4 as coupled to the tube sheets 4 in penetrating through the tube sheets 4. Coupling members 8, formed with either of an inlet 6 and an outlet of the EGR gas, are coupled to opposite ends of the body pipe 3.

An introduction route 10 for supplying the cooling medium liquid to the heat exchanger 5 and a delivery route 11 for discarding the cooling medium liquid after the heat exchange are arranged at the body pipe 3, thereby circulating the cooling medium liquid in the heat exchanger 5. The heat exchanger 5 is formed with plural supporting plates 13 provided inside in a coupling manner, and the heat conduction pipes 1 are inserted in the supporting plates 13 to support the heat conduction pipes 1 stably as buffle plates, to render the flow of the cooling medium liquid flowing inside the heat exchanger 5 meandered, and to raise the correlative rate with respect to the outer surface of the heat conduction pipe 1.

The thermal medium fluid having the high boiling point of 150 degrees Celsius or higher is supplied to the heat exchanger 5 via the introduction route 10, and the cooling medium liquid delivered to the delivery route 11 is collected, thereby cooling the cooling medium liquid whose temperature is increased by heat exchange done with the EGR gas. A cooling medium cooling portion 12 is disposed for supplying the cooling medium liquid to the heat exchanger 5 again via the introduction route 10, and as shown in FIG. 1, the cooling medium liquid thus can be circulated in the EGR gas cooling apparatus. The cooling medium cooling portion 12 can be of an air-cooled method using an radiator and can be of a water-cooled method using a cooling medium liquid such as a cooling water.

By disposing a circulation pump 14 and a control valve 15 at the introduction route 10 of the cooling medium liquid, and a controller 16 may be provided for controlling increase and decrease of the supplying amount of the cooling medium liquid from the cooling medium cooling portion 12 to the heat exchanger 5 and for controlling stop of the supply. The operation of the controller 16 made of the circulation pump 14 and the control valve 15 can be controlled by ECU (Electronic Control Unit) 17 for controlling the internal combustion engine, and the ECU 17 makes an access to the controller 16 based on measured temperatures from a heat conduction pipe temperature sensor 18 for measuring the inner surface temperature of the heat conduction pipe 1 disposed in the apparatus, an EGR gas temperature sensor 20 for measuring an outlet temperature of the EGR gas, and a cooling medium temperature sensor 21 for measuring an outlet temperature of the cooling medium liquid, thereby adjusting the supplying amount of the thermal medium fluid having the high boiling point of 150 degrees Celsius or higher. The adjustment of the supplying amount of the thermal medium fluid having the high boiling point of 150 degrees Celsius or higher is not necessarily required, and it is merely useful for a particular purpose such as attachment of the soot to the flowing route.

An expansion tank 22 for the thermal medium fluid having the high boiling point of 150 degrees Celsius or higher may be provided to the introduction route 11 as shown with the dotted line in FIG. 1. This tank 22 can absorb expansions and contractions of the cooling medium liquid produced by temperature changes of the cooling medium liquid, thereby allowing smooth circulation of the cooling medium liquid in the EGR gas cooling apparatus and allowing the pressure in the apparatus to be kept constant. The expansion tank 22 can be used as an auxiliary tank when adjusting the flowing amount of the cooling medium liquid at the controller 16, and where the heat exchanger 5 is excessively heated or where the EGR gas amount is increased, supply of the cooling medium liquid from the expansion tank 22 increases the circulation amount of the cooling medium liquid at the heat exchanger 5 to improve the heat exchange efficiency at the heat exchanger, thereby preventing the apparatus from overly heated during the heat exchange operation. Conversely, where the heat exchanger 5 is subject to a lower temperature or where the EGR gas amount is reduced, the cooling medium liquid is collected into the expansion tank 22 to reduce the circulation amount of the cooling medium liquid at the heat exchanger 5, thereby reducing the heat exchange efficiency to prevent the interior of the heat exchanger 5 from subjecting to a lower temperature.

With the EGR gas cooling apparatus thus described, the heat exchange is conducted by introducing the heated EGR gas into the body pipe 3 via the inlet 6 from the side of the exhaust manifold, and the EGR gas flows into the heat conduction pipes 1 provided in a plural number in the body pipe 3. The cooling medium liquid flows in the meandered manner along the external circumferential surface of the heat conduction pipes 1 at the heat exchanger 5 disposed to the exterior of the heat conduction pipes 1, so that the heat exchange is performed between the EGR gas and the thermal medium fluid having the high boiling point of 150 degrees Celsius or higher via the inner and outer surfaces of the heat conduction pipes 1.

In the heat exchange, the inner surface temperature of the flowing route 2 of the heat conduction pipe 1 is preferably maintained in a range of 120 degrees Celsius through 150 degrees Celsius. To remove the soot attached on the inner surface of the flowing route 2 and to prevent the soot from attaching, the ECU 17 controls the controller 16 where reduction of the inner surface temperature of the heat conduction pipe 1 is sensed by the heat conduction pipe temperature sensor 18 or where reduction of the outlet temperatures of the EGR gas and the cooling medium liquid is sensed by the EGR gas temperature sensor 20 and the cooling medium temperature sensor 21, thereby reducing the flowing amount upon choking the circulation pump 14, or thereby reducing the supplying amount of the cooling medium liquid to the heat exchanger 5 or stopping the supply by stopping the circulation pump 14, or by choking or stopping of the control valve 15.

With this manipulation, since the heat exchange efficiency at the heat exchanger 5 is lowered, the inner surface temperature of the flowing route 2 of the heat conduction pipe 1 is increased, and the entire temperature of the heat exchanger 5 may be increased. The ECU 17 can always monitor respective temperature changes at the heat exchanger 5 from the respective temperature sensors 18, 20, 21. Where the inner surface temperature of the flowing route 2 is maintained in the range of 120 degrees Celsius through 150 degrees Celsius, soot attachment prevention effect to the inner surfaces is raised, and soot deposition to the inner surface of the flowing route 2 can adequately be prevented without generation of condensation of such as vapor, unburned gas, sulfuric acid solution, and carbon hydride contained in the EGR gas.

Even where dried soot in a quite small amount is deposited on the interior of the heat conduction pipe 1, because being of a dry soot layer having a lower bulk density of the particles and a low viscosity, this soot layer can be separated and blown away easily from the inner surface of the flowing route 2 by the flowing force of the EGR gas, and the soot pulverized into small debris is discarded to the outlet 7 together with the EGR gas. Such small dried soot may not affect the internal combustion engine even where sent to the side of the intake manifold. Because the thermal medium fluid having the high boiling point of 150 degrees Celsius or higher is used, the cooling medium liquid does not boil from a high temperature of the heat conduction pipe 1, so that the parts of the heat exchanger 5 can be prevented from broken down or deteriorated.

Because the ECU 17 always monitors the temperatures of the heat exchanger 5 from the respective temperature sensors 18, 20, 21, the heat exchanger 5 can be prevented from excessively heated where the ECU 17 accesses the controller 16 to promote the heat exchange by increasing the supplying amount of the cooling medium liquid to the heat exchanger 5 upon increasing the flowing amount of the circulation pump 14 or releasing the control valve 15, where the heat exchanger 5 is heated more than the targeted temperature.

As described above, from the high temperature of the inner surface of the flowing route 2, this mechanism does prevention against soot attachment onto the heat conduction pipes 1 and removal of soot, and the thermal conductivity of the heat conduction pipes 1 may be lowered, so that the heat exchanger 5 always effectively does heat exchanging operation, and so that this EGR gas cooling apparatus can operate with higher functionality.

The ECU 17 can be designed so that heating of the flowing route 2 for the EGR gas is done at a time when the respective temperature sensors 18, 20, 21 detect the lowered temperatures of the flowing route 2, or can be designed to do heating periodically at every prescribed time. Such heating brings adequately soot attachment prevention effects and removal effects even in a short time, so that such heating can be done during driving without stopping the engine, and as a matter of course, it can be designed so that heating is done during engine stop.

As described, this invention thus structured renders the inner surface temperature of the flowing route of the EGR gas such as the heat conduction pipes and the heat conduction plates subject to a high temperature without boiling the cooling medium liquid to sufficiently prevent the soot from depositing on the flowing route, and can remove the soot easily from the flowing route by promoting soot's separation and blowing away from the inner surface where the soot has the lower bulk density of the particles and the lower viscosity even in case that the soot deposits on the inner surface of the flowing route. Consequently, reduction of the thermal conductance at the flowing route due to soot is minimized, and this mechanism can perform the heat exchange efficiently between the EGR gas flowing in the flowing route and the cooling medium liquid flowing the outer periphery of the flowing route. By adjusting the supplying amount of the cooling medium liquid to the heat exchanger by the controller, the heat exchanger is prevented from excessively chilled and heated, thereby improving the product durability, as well as raising commercial values of products by maintaining the excellent cooling functions of the EGR gas.

By rendering the inner surface of the heat conduction pipe at a high temperature, attachments of condensed liquids upon condensation of such as vapor, unburned gas, sulfuric acid solution, and carbon hydride contained in the exhaust gas can be prevented, so that the structural members such as the heat conduction pipes can avoid to be corroded, and the mechanism can acquire high durability and high reliability.

What is claimed is:

1. An EGR gas cooling mechanism comprising:
a heat exchanger coupled to an introducing route and a delivery route for a cooling medium liquid for cooling EGR gas, the heat exchanger comprising:
a body pipe having an inlet for the EGR gas located at one end and an outlet for the EGR gas located at the other end;
a flowing route for EGR gas provided inside the body pipe,
wherein a thermal medium fluid having a high boiling point of 150 degree Celsius or higher is supplied as the cooling medium liquid to the heat exchanger to prevent soot and condensed liquid from being attached to an inner surface of the flowing route of the EGR gas by heating operation for the inner surface of the flowing route of the EGR.

2. An EGR gas cooling mechanism comprising:
a heat exchanger coupled to an introducing route and a delivery route for a cooling medium liquid for cooling EGR gas, the heat exchanger comprising:
a body pipe having an inlet for the EGR gas located at one end and an outlet for
the EGR gas located at the other end;
a flowing route for EGR gas provided inside the body pipe,
wherein a controller for controlling supply of the cooling medium liquid is provided at the flowing route in which a thermal medium fluid having a high boiling point of 150 degrees Celsius or higher is supplied as the cooling medium liquid to the heat exchanger.

3. The EGR gas cooling mechanism according to claim 2, wherein the controller includes a circulation pump disposed at the introduction route for the cooling medium liquid and a control valve, and wherein a supplying amount of the cooling medium liquid supplied to the heat exchanger is controlled by either or both of increasing and decreasing operation for flowing amount of the circulation pump and opening and closing operation of the control valve.

4. The EGR gas cooling mechanism according to claim 2, wherein the controller controls the supplying amount of the cooling medium liquid to the heat exchanger according to any of temperature or temperatures at the surface of the flowing route of the EGR, the outlet of the cooling medium liquid, and the outlet of the EGR gas.

5. The EGR gas cooling mechanism according to claim 1, wherein the heating operation for the inner surface of the flowing route of the EGR gas is made in range between 120 degrees Celsius and 150 degree Celsius.
